(19) United States
(12) Patent Application Publication
(10) Pub. No.: US 2026/0154542 A1
(43) Pub. Date: Jun. 4, 2026

(54) Synthetic Neurons and Networks with Feedback Quantum Tunneling Memristors

(71) Applicant: The United States of America, as represented by the Secretary of the Navy, Arlington, VA (US)

(72) Inventors: Osama M. NAYFEH, Temecula, CA (US); Haik D. MANUKIAN, San Diego, CA (US); Matthew E. KELLY, San Diego, CA (US); Justin M. MAUGER, San Diego, CA (US)

(73) Assignee: The United States of America, as represented by the Secretary of the Navy, Arlington, VA (US)

(21) Appl. No.: 18/954,780

(22) Filed: Nov. 21, 2024

(51) Int. Cl. G06N 3/063; G06N 3/049; G06N 10/40

(52) U.S. Cl. CPC G06N 3/063; G06N 3/049; G06N 10/40

(57) ABSTRACT

The present invention is synthetic neurons and networks with feedback quantum tunneling memristors designed to mimic biological neurons. The memristor hardware is formed from a 4.2 nm thick layer of atomic layer deposited ionic hafnium oxide and niobium metal and inserted in the positive and negative feedback of an analog spiking oscillator. When operated at room/warm temperatures, these memories have memristive properties and enable the artificial neuron circuits to produce adaptive spiking behavior. When neural networks are formed of the synthetic neurons, pronounced hybrid chaotic/non-chaotic modes with increased complexity are observed and itinerant behavior emerges. Cryogenic cooling of the memristors into the superconducting Josephson tunneling regime at 8.1 K reveals the influence of quantum control effects.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice: (619) 553-5118; email: NIWC_Pacific_T2@navy.mil. Reference Navy Case Number 211633.

### BACKGROUND OF THE INVENTION

Field of the Invention: The present invention relates generally to synthetic neurons used to mimic biological systems. More particularly, the present invention relates to synthetic neurons and networks with feedback quantum tunneling memristors.

Description of Related Art: Biologically inspired artificial intelligence and machine learning (AI/ML), synthetic neurons and other technologies have a grand goal of mimicking the intelligence of biological organisms spanning from insects to mammals and up to the human experience. It is desirable to have synthetic neurons that mimic the response of biological neurons, as neurons and their complex networks account for many of the behaviors of biological systems.

Conventional approaches to understanding and designing various synthetic neurons range from emulation on digital computers to analog complementary metal oxide semiconductor (CMOS) designs. Conventional artificial neuron circuit designs are typically aimed at matching a circuit response that can produce operations to mimic the known output response of biological neurons, as extracted either experimentally from neuroscience experiments or modeled with biological models. These biological neuron models range in complexity and biological inspiration. Such conventional approaches typically emulate neuron models with digital and analog transistor circuits. However, conventional synthetic neurons may lack sufficient built-in memory, nonlinear dynamical behavior, and quantum phenomenon in their operation to come close to biological functionality.

In view of the foregoing and for other reasons that will become evident, there is a need in the art for the discovery and design of artificial neuron hardware that mimics the advanced functionality and operation of the neural networks available in biological organisms.

### SUMMARY OF THE INVENTION

An embodiment of a memristor is disclosed. The embodiment of a memristor may include a first electrode comprising niobium (Nb), a second electrode comprising Nb, and an intermediate layer of ionically active hafnium oxide (HFOₓ) having a thickness, disposed in between, in electrical contact with, and separating the first and the second electrodes.

An embodiment of a synthetic neuron for generating spiking modes mimicking biological neurons, the synthetic neuron having an input signal (IN) and an output signal (OUT) is disclosed. The embodiment of a synthetic neuron may include an operational amplifier with a negative input, a positive input connected to the IN, an output connected to the OUT, a positive direct current (DC) bias voltage and a negative DC bias voltage; a diode D1 having anode connected to ground and cathode connected to the OUT; a resistor R3 connected between ground and the negative input; a resistor R4 connected between ground and the positive input; a capacitor C2 connected between ground and the positive input; a first memristor having first and second electrodes, wherein the first electrode is connected to the negative input; a resistor R1 connected between the second electrode of the first memristor and the OUT; a second memristor having first and second electrodes; a capacitor C1 connected between the positive input and the first electrode of the second memristor; and a resistor R2 connected between the second electrode of the second memristor and the OUT.

An embodiment of a neural network is disclosed. The embodiment of a neural network may include a plurality of synthetic neurons, arranged in columns and rows, each of the synthetic neurons configured for generating spiking modes mimicking biological neurons, having an input signal (IN) and an output signal (OUT); and wherein the IN of each column of the synthetic neurons are connected to each other and the OUT of each column of the synthetic neurons are connected together and to IN of each subsequent column of the synthetic neurons.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following drawings illustrate exemplary embodiments for carrying out the invention. Like reference numerals refer to like parts in different views or embodiments of the present invention in the drawings.

FIG. 1 is a circuit diagram of an embodiment of a synthetic neuron, according to the present invention.

FIG. 2 is a graph illustrating a classical spiking model output of the synthetic neuron, according to the present invention.

FIG. 3 is a graph illustrating a strong non-linear functionality that results in a hybrid chaotic mode of the synthetic neuron, according to the present invention.

FIG. 4 is a graph illustrating the phase-plane trajectories of the synthetic neuron where signs of itinerancy are apparent, according to the present invention.

FIG. 5 is a circuit diagram of a network of nine synthetic neurons, according to the present invention.

FIG. 6 illustrates graphs of the simulated output (bottom) and the dynamics of memristor dynamical state variables (top) upon the application of a small sinusoidal stimulus signal, according to the present invention.

FIG. 7 is a graph illustrating pulsed current/voltage (IV) measurements of a memristor taken at room temperature sweeping forward and reverse from −2.0 V to 2.0 V with 300/900 ns pulse widths and 60/100 ns rise/fall times, according to the present invention.

FIG. 8 is a plot of In(I/V²) vs 1/V for the memristors illustrating direct tunneling (DT) and field-effect tunneling (FN), according to the present invention.

FIG. 9 is a representative energy band diagram illustrating the expected tunneling electron flow through the memristors, according to the present invention.

FIG. 10 is a graph illustrating synthetic neuron output signals (OUT) with changing DC bias voltages, according to the present invention.

FIG. 11 is a graph of exemplary synthetic neuron output signals (OUT) with DC only and DC plus RF input (IN) stimulus, according to the present invention.

FIG. 12 is a graph illustrating the extracted spiking rates vs time for the output signals illustrated in FIG. 11, according to the present invention.

FIG. 13 is a graph illustrating an example of the phase-plane trajectories of a single artificial neuron at room temperature that produces hybrid non-chaotic/chaotic attractor modes, according to the present invention.

FIGS. 14-16 are graphs illustrating examples of the phase-plane trajectories of multiple artificial neurons at room temperature, where the complexity observably increases, consistent with the formation of a neural network, according to the present invention.

FIG. 17 is a graph illustrating the measured current vs. voltage data of an embodiment of a Nb—HfOₓ—Nb memristor taken at a temperature of 8.1 K sweeping from +1.0 mV in the forward and reverse directions, according to the present invention.

FIGS. 18 and 19 are graphs illustrating two examples of the collected experimental spectra with repeated measurement and modulated intensity, plotting the output voltages at the two respective memory nodes (V₁ and V₂, see FIG. 1) vs. time, according to the present invention.

FIGS. 20, 21 and 22 are graphs illustrating the phase-space for increasing excitation strength and when a network is formed, according to the present invention.

FIGS. 23-26 illustrate memristor output response based on the quantum master equation (QME) under different conditions, according to the present invention.

FIGS. 27 and 28 illustrate the calculated correlation functions shown in Eqs. 8 and 9, according to the present invention.

FIG. 29 is a two synthetic neuron network, according to the present invention.

FIG. 30 is an exemplary graph of spiking output when the memristors of one synthetic neuron (right side of FIG. 29) are cooled to 8.1 K, according to the present invention.

FIGS. 31 and 32 are three-dimensional plots illustrating the two synthetic neuron network output voltage behavior as a function of time, according to the present invention.

FIG. 33 is a composite graph illustrating various exemplary types of spiking modes and the associated dynamical state variables produced by simulations of the synthetic neuron circuit with changing levels of non-volatility, according to the present invention.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment but may be expanded for use with any of the other methods, apparatuses and systems described herein as will be understood by one of ordinary skill in the art unless specifically otherwise stated.

Synthetic or artificial neurons offer several useful applications and benefits, particularly in the fields of computing, robotics, and neuroscience. One advantage of synthetic neurons may include enhanced computing power. Synthetic neurons can process information in a way that mimics biological neural networks, enabling advanced computing models like neuromorphic computing, which can perform tasks like pattern recognition and decision-making more efficiently than conventional computers. Another advantage of synthetic neurons may include energy efficiency. By mimicking the energy-efficient operations of biological neurons, synthetic neurons can potentially reduce power consumption in computational tasks, making them suitable for mobile and embedded systems. Other advantages of synthetic neurons include learning and adaptation. Synthetic neurons can exhibit learning capabilities through mechanisms like synaptic plasticity, allowing them to adapt their behavior based on experience and improving their performance over time. Another advantage of synthetic neurons may include robustness to damage. Artificial neurons can be designed to be resilient to noise and damage, maintaining functionality even when some components fail, which is beneficial in real-world applications. Another advantage of synthetic neurons may include biocompatibility in biomedical applications. Synthetic neurons may be engineered to interact safely with biological tissues, offering potential for neural prosthetics, brain-machine interfaces, and therapies for neurological disorders. Another advantage of synthetic neurons may include scalability. Synthetic neurons can be manufactured at a small scale, enabling the creation of large-scale neural networks that can be integrated into various devices and systems, from simple sensors to complex AI systems. Another advantage of synthetic neurons is interconnectivity. Synthetic neurons can be designed to connect easily with other synthetic neurons and components, facilitating the development of complex systems that can perform sophisticated tasks, such as adaptive robotics and intelligent systems. Another advantage of synthetic neurons is versatility. Synthetic neurons can be tailored for specific tasks, such as sensory processing, motor control, or decision-making, making them adaptable for a wide range of applications. From a purely research perspective, synthetic neurons are useful for understanding neural mechanisms. Research and development of synthetic neurons can provide insights into the functioning of biological neurons and neural circuits, contributing to advancements in neuroscience. Additionally, synthetic neurons have the potential for advancing AI technologies. By mimicking the structure and function of biological neurons, synthetic neurons can contribute to the development of more advanced artificial intelligence systems that exhibit cognitive-like capabilities. For all of the above reasons, the development and fielding of functioning synthetic neurons is highly desirable.

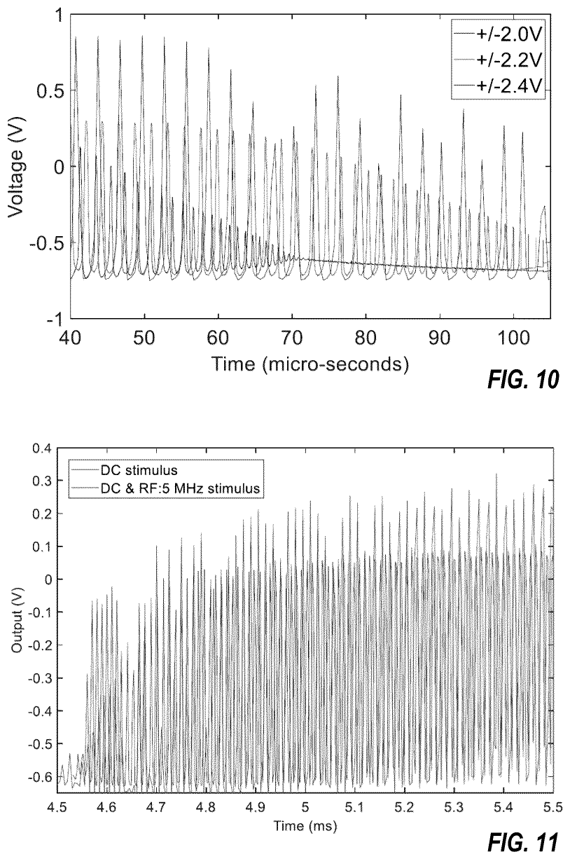

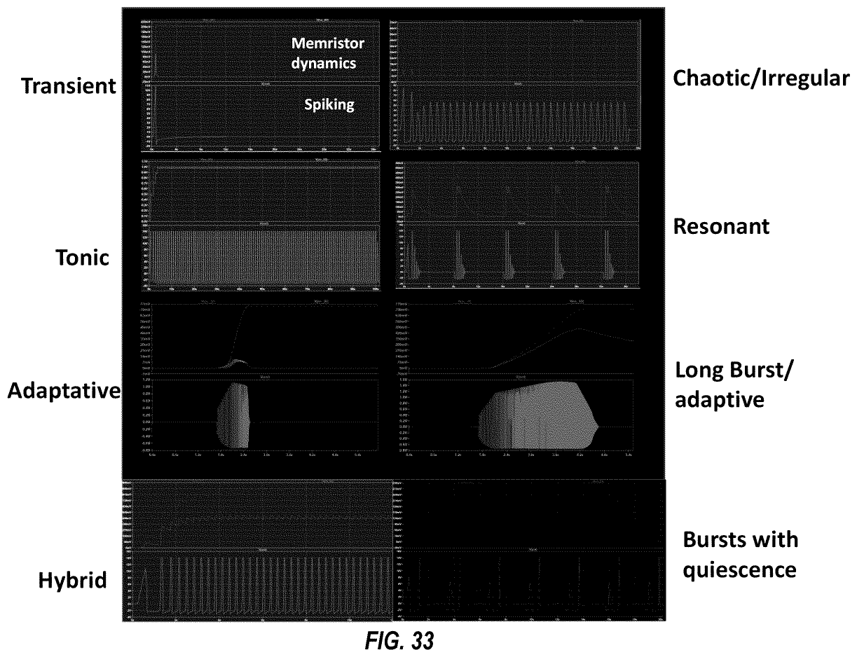

The present invention solves the technical problem of providing an electric circuit-based synthetic neuron that is capable of generating a wide variety of spiking patterns which are highly relevant for biomimicry. For example, it is known that biological brains use various types of spiking patterns in their processing, such as those illustrated in FIG. 10 and FIG. 33 as further discussed herein. The design of the inventive synthetic neuron circuits disclosed herein employ a Wien oscillator with memristors inserted in the positive and negative feedback loops of the oscillator circuit.

The inventors provide additional disclosure of the present invention in O. M. Nayfeh, H. Manukian, M. Kelly and J. Mauger, “Adaptive spiking, itinerancy, and quantum effects in artificial neuron circuit hardware with niobium-hafnium oxide-niobium memristor devices inserted”, AIP Advances 14, 085228 (2024), including Supplementary Materials, the contents of which are hereby incorporated by reference for all purposes as if fully set forth herein.

Synthetic neurons require a dynamical operation and ability to produce many spiking patterns and hybrids, as well as combined oscillations when networked. The response must be adaptable with rapidly changing stimulus (a daunting challenge for conventional digital emulation approaches in the literature) as a means of information encoding and facilitating subsequent computational functions for learning and memory operations. In addition to producing spiking that mimics biological behavior and the response of biological neuron models such as Hodgkin-Huxley (HH), and Adaptive Exponential (AdEx), a metric of complex and autonomous learning and spontaneous ability for a synthetic neuron is the emergence of itinerant and edge of chaotic dynamics. Such complexity requires a circuit that represents a high order, non-linear dynamical system of several coupled state variables.

Memristors provide dynamical memory and other non-linearity in a similar fashion to ion-channels and also with properties that are shown to be attributed to biological microtubules, etc. Memristors also provide a control of the natural dissipative (non)-volatility from short-to-long term memory effects, that can be used to provide inhibitory and excitatory feedback for reinforcement and other learning and memory operations. Memristors provide a dynamic and non-linear operation and memory effect, where the most common mechanism is reversible ionic motion in a thin film. Reducing this film, to the point where quantum tunneling is the primary conduction mechanism provides for a faster and lower voltage operation and emergence of quantum effects. Memristive circuits can output various spiking modes. But, observation of hybrid non-chaotic/chaotic attractor modes and itinerancy, where time is spent in changing attractor modes, requires increased non-linearity and feedback.

Aspects of the present invention include a high-speed artificial neuron circuit and networks with quantum tunneling memristor hardware inserted in the positive and negative feedback loops of an analog spiking oscillator. The terms “synthetic neuron” and “artificial neuron” are used synonymously herein. Additionally, the terms “synthetic neuron network” and “neural network” are used synonymously herein. The inventive artificial neuron provides inhibitory and excitatory dynamics in a coupled non-linear dynamical system with built-in synaptic memory. The inventive artificial neuron provides inhibitory and excitatory dynamics in a coupled non-linear dynamical system with built-in synaptic memory. Further novel and nonobvious features of the synthetic neurons of the present invention and networks of same include: adaptive properties, hybrid non-chaotic/chaotic modes, and the emergence of strong itinerant behavior when networked.

According to particular embodiments of the present invention, quantum tunneling memristors are inserted in both the positive and negative feedback loops of a Wien oscillator and provide built-in short-and-long term memory effects that results in a highly non-linear coupled system. The synthetic neuron is capable of adapting its spiking pattern with stimulus from short to long bursts and with changing the spiking rate.

The inventive synthetic neurons and networks demonstrate in hardware many behaviors of biological neurons ranging from stable operation to adaptation and itinerant hybrid chaotic/non-chaotic dynamics. The integration of memristors in the synthetic neurons provides dynamical control and a large level of programmability in the spiking response. By cooling the memristors to the superconducting quantum regime, the inventors observed results consistent with stochastic master equation and quantum jump theory calculations. Additionally, the inventors disclose several application building blocks in gait control, neuron-neuron communications, and autonomous learning. More particularly, when the memories are in the superconducting state, Josephson tunneling emerges. This results in a new solid-state superconductor-ionic system, where signs of the influence of coherent quantum control are observed in accordance with the quantum master equation (QME) calculations of the expectation values and correlation functions using a calibrated time-dependent Hamiltonian under strong driving field conditions. Another useful application of the invention is a four-neuron ring network performing autonomous learning and the modulation of signals that exploit the biologically inspired functionality.

### Synthetic Neuron

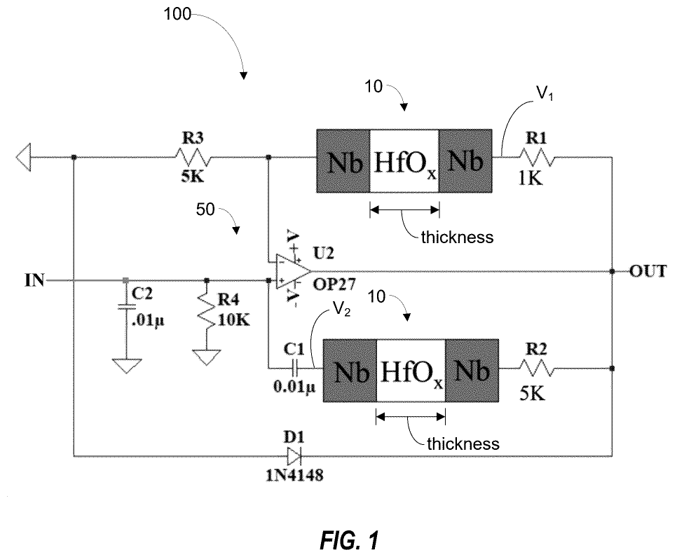

FIG. 1 is a circuit diagram of an embodiment of a synthetic neuron 100, according to the present invention. The embodiment of a synthetic neuron 100 includes Nb—HfOₓ—Nb quantum tunneling memristor devices 10 located in the positive and negative feedback loops of an analog Wien oscillator, shown generally at arrow 50. The illustrated embodiment of the synthetic neuron 100 includes an operational amplifier U2 with negative input connected in between the upper memristor 10 and one end of resistor R3 with other end connected to ground. The input signal (IN) node of the synthetic neuron 100 includes a capacitor C2 tied to ground, a resistor R4 also tied to ground and a capacitor C1 connected to the lower memristor 10. The output signal (OUT) node of the synthetic neuron 100 is connected to the output of the operational amplifier U2, connected to resistor R1 which is tied to the upper memristor 10 and connected to resistor R2 which is tied to the lower memristor 10. Finally, a diode D1 with cathode tied between the output signal (OUT) node and anode tied to ground. The novel insertion of a one way diode D1 in the Wien circuit forces the output signal (OUT) voltage oscillations to be positive. This feature makes the voltage traces resemble spikes.

Embodiments of each memristor 10 may include a thickness of ionically active hafnium-oxide (HfOₓ) sandwiched between niobium (Nb) electrodes. The thickness of the HfOₓ may be selected such that the memristor 10 operates in a regime that direct quantum mechanical tunneling (DT) dominates. For HfOₓ with niobium electrodes as disclosed herein, a HfOₓ thickness of about 4.2 nm is optimal. Thus, according to a particular embodiment of memristor 10 the thickness of the HfOₓ may be about 4.2 nm and formed through atomic layer deposition (ALD). It will be understood that alternative ionic film materials with alternative thicknesses may also be employed consistent with the teachings of the present invention. It will be further understood that the level of ionic states and thickness of such an ionic film may be selected to balance memristor programming time and non-volatility. Note also that use of a superconducting ionic film provides for entering into a regime where Josephson tunneling is present and thus enabling quantum control effects. Though particular embodiments of the invention are disclosed herein, it will be understood that alternate materials or oscillator backbone circuits can be used to provide similar effects provided that the circuit elements are optimized appropriately to provide the proper system non-linear order and feedback properties in accordance with the derived mathematical model.

The architecture of synthetic neuron 100 is designed to be a biologically inspired artificial neuron, requiring a continuous dynamical operation with the ability to produce a vast array of spiking patterns. The response of the synthetic neuron 100 is configured to be modulated when stimulated, as a means of information encoding and for facilitating subsequent computational functions. The design of the synthetic neuron 100 integrates memristors 10 in both the positive and negative feedback loops of a Wein oscillator 50 to provide dynamical control of the dynamics of the state variables and a high level of itinerancy and adaptability. At room temperature, the memristors 10 operate as memristive devices due to the ionically active HfOₓ. When cryogenically cooled into the superconducting state, the memristors 10 operate as superconducting quantum effect memories that also exhibit Josephson tunneling. During dynamical operation of the synthetic neuron 100, the memory states in the feedback loops are adjusted by the bias voltages in the operational amplifier U2 and level of current flow. The resistances R1-R4 and capacitances C1 and C2 help adjust the spiking rates. The operational amplifier U2 enables feedback and coupling between the memristors 10, and the diode D1 provides stabilization. Inhibitory and excitatory impacts on the memory states of the memristors 10 and their non-linearity enable adaptive spiking as the output response (OUT) of synthetic neuron 100.

Specific embodiments of the non-memristor components may have the parameters and part numbers illustrated in FIG. 1. More particularly, R1 may have a resistance of 1 KΩ, R2 may have a resistance of 5 KΩ, R3 may have a resistance of 5 KΩ, R4 may have a resistance of 10 KΩ, C1 and C2 may each have a capacitance of 0.01 μF, D1 may have part number 1N4148, available from Vishay Semiconductors, (Vishay Intertechnology, Inc.), 63 Lancaster Avenue, Malvern, PA 19355-2143, U.S.A., and operational amplifier U2 may have part number OP27 available from Analog Devices, One Technology Way, P.O. Box 9106, Norwood, MA 02062-9106, U.S.A. However, it will be understood that other component values and part numbers of the illustrated synthetic neuron 100 with similar functionality may be used in other embodiments consistent with the teachings of the present invention.

The inventors derived a full analytical model for the output, vₒ(t), as shown in Eq. 1, below, using Kirchhoff's voltage and current law nodal analysis.

$$\frac{{d}^{2} {v}_{o} ( t )}{{dt}^{2}} + ( \frac{{R}_{Mem 2} ( t )}{{R}_{3}} + \frac{{C}_{1}}{{C}_{2}} + \frac{{dR}_{Mem 2} ( t )}{dt} {C}_{1} + \frac{{R}_{Mem 1} ( t )}{{R}_{4}} ) \times \frac{1}{{R}_{Mem 1} ( t ) {C}_{1}} ( \frac{{dv}_{o} ( t )}{dt} ) + ( \frac{1}{{R}_{3} {C}_{2}} + ( \frac{1}{{R}_{3}} ) ( \frac{{dR}_{Mem 2} ( t )}{dt} ) ) \times \frac{1}{{R}_{Mem 2} ( t )} {v}_{o} ( t ) = 0 \qquad Eq . 1$$

Non-linear differential Eq. 1 is solved numerically while coupled with the non-linear equations for the memory dynamical state variables x_{Mem1}(t) and x_{Mem2}(t) and the memrisistances R_{Mem1}(t) and R_{Mem2}(t) using Eq. 2 and Eq. 3 shown below.

$$\frac{{dx}_{Mem} ( t )}{dt} = λ [ {η}_{1} sinh ( {η}_{2} V ( t ) ) - \frac{f ( V , x , T ) {x}_{Mem} ( t )}{τ} ] \qquad Eq . 2$$

$${R}_{Mem} ( t ) = \frac{V ( t )}{( ( 1 - {x}_{Mem} ( t ) ) α [ 1 - {e}^{β V ( t )} ] + {x}_{Mem} ( t ) γ sinh ( δ V ( t ) ) )} \qquad Eq . 3$$

where the non-linear hyperbolic dependencies capture the excitation voltage V(t) dependent ionic drift-diffusion processes in metal-oxide memristors. The parameters γ, δ, α, and β, are prefactors and exponents that adjust the levels of quantum tunneling and Schottky emission, and λ, η₁, and η₂ are adjustable state variable pre-factors. τ is a diffusion constant that represents the level of short- and long-term memory, i.e., non-volatility.

The inventors introduce a functional dependence f(V, x, T) to capture the non-linear dependence of the ion velocity with temperature in accordance with the Eq. 4,

$$υ \approx {ae}^{( \frac{- {U}_{a}}{{k}_{b} T} )} sinh \frac{qEa}{2 {k}_{b} T} \qquad Eq . 4$$

where U is an activation energy, a is the ion periodicity, E is the electric field strength, and k_{b}T is the thermal energy. The resistances R1-R4 and capacitances C1 and C2 of the synthetic neuron 100 were selected considering the memristors 10. Additionally, capacitors C1 and C2 were selected within the 100 nF-1 μF range and resistors R1-R4 were selected within the 1-10 kΩ range to obtain a MHz speed response.

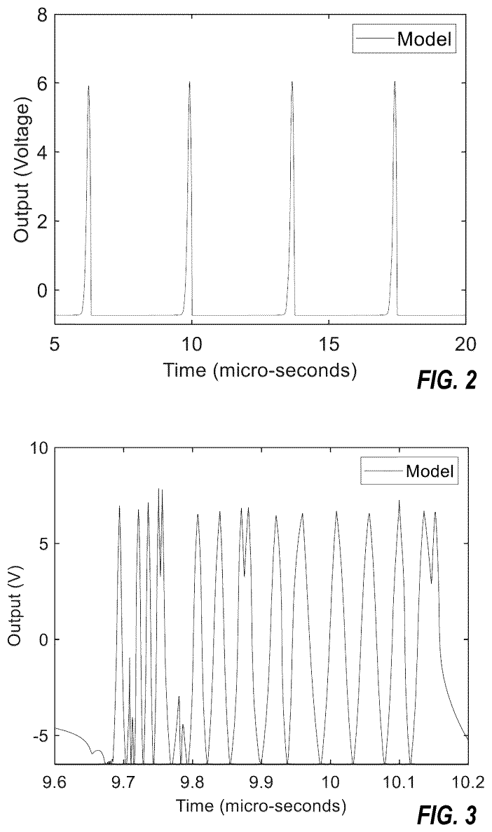

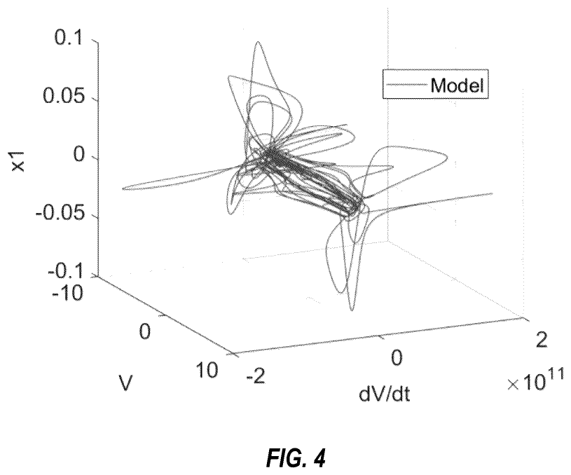

FIG. 2 illustrates a classical spiking model output of the synthetic neuron 100, according to the present invention. As illustrated in FIG. 2, the synthetic neuron 100 exhibits classical spiking in voltage, OUT, over regular time, t, intervals. In contrast, FIG. 3 illustrates a strong non-linear functionality that results in a hybrid chaotic mode of the synthetic neuron 100, according to the present invention. As illustrated in FIG. 3, the output voltage, OUT, is irregular and chaotic over time, t. FIG. 4 is graph illustrating the phase-plane trajectories of the synthetic neuron 100 where signs of itinerancy are apparent.

### Network of Synthetic Neurons

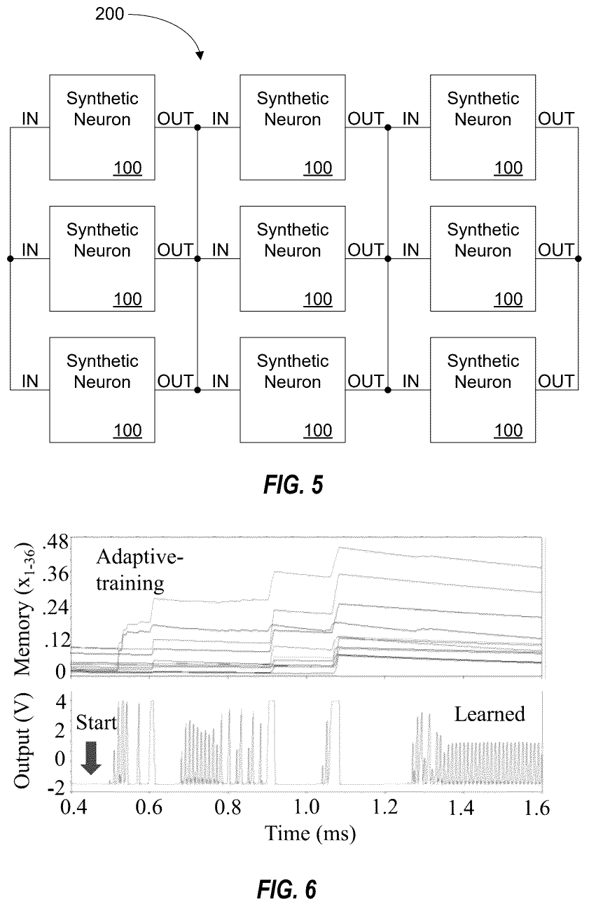

FIG. 5 is a circuit diagram of a network of nine synthetic neurons 200, according to the present invention. More particularly, network 200 incorporates 3 columns and 3 rows of synthetic neurons 100. As shown in FIG. 5, the output (OUT) signals of each wave (column) of three synthetic neurons 100 are tied together and to the input (IN) of each subsequent wave (column) of three synthetic neurons 100.

FIG. 6 illustrates graphs of the simulated output (bottom) and the dynamics (top) of the memristor dynamical state variables upon the application of a small sinusoidal stimulus signal to the network 200, according to the present invention. It will be understood that neural networks formed with the synthetic neurons 100 disclosed herein may be arranged in any suitable configuration of m columns and n rows. As shown in FIG. 6, the output (bottom) starts with adaptive training and finally reaches a steady state spiking output that represents the learned encoded information that was reinforced by the autonomous learning as determined from the memristors dynamical state variables.

### Adaptive and Hybrid Spiking Behavior

The inventors experimentally examined an experimental synthetic neuron 100 circuit using memristor/resistive switching (ReRAM) hardware constructed on silicon wafers with 4.2 nm of atomic layer deposited (ALD) ionically active hafnium-oxide (HfOx) and sputtered niobium (Nb) electrodes, i.e., (Nb—HfOx-Nb) produced with the process disclosed in L. Lerum, M. Fahem, O. M. Nayfeh, C. D. Rees, K. S. Simonsen, and A. D. Ramirez, “Low voltage and high-speed niobium heterostructure resistance switching memory devices integrating ferro-electric enhanced aluminum-hafnium-chromium-aluminum oxide,” IEEE J. Electron Devices Soc. 5, 347-361 (2017), the contents of which are hereby incorporated by reference for all purposes as if fully set forth herein.

The inventors independently characterized the Nb—HfOx-Nb memristors 10.

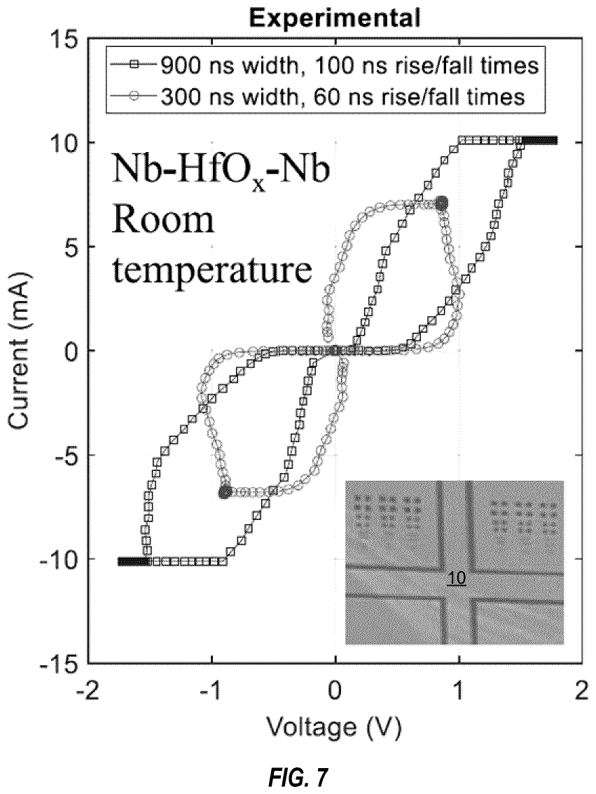

FIG. 7 is a graph illustrating pulsed current/voltage (IV) measurements taken at room temperature sweeping forward and reverse from −2.0 V to 2.0 V (voltage range) with 300/900 ns pulse widths and 60/100 ns rise/fall times, according to the present invention. FIG. 7 further illustrates a partial image of a Nb—HfOx-Nb memristor 10 as an inset, lower right. Note the characteristics shown in FIG. 7 are non-linear with a significant hysteresis and resistance switching of current of 4-5 orders of magnitude.

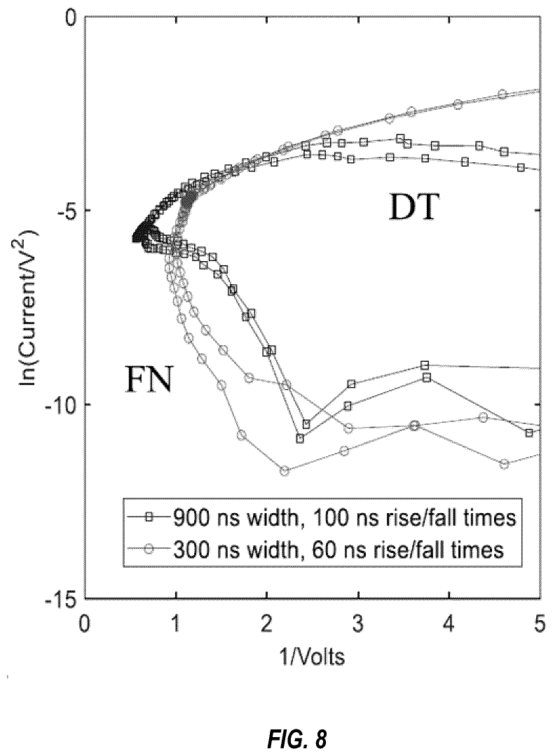

FIG. 8 is a plot of In(I/V²) vs 1/V for the memristors 10, according to the present invention, illustrating direct quantum mechanical tunneling (DT) and Fowler Nordheim tunneling (FN). The primary conduction mechanism for this voltage range and with 4.2 nm of HfOₓ and a Nb—HfOₓ barrier of 2.2 eV is by direct and field-effect quantum tunneling as determined from the dependency from a plot of In(I/V²) vs 1/V, as shown in FIG. 8, where regimes of direct tunneling (DT) with a transition to field-effect tunneling is evident.

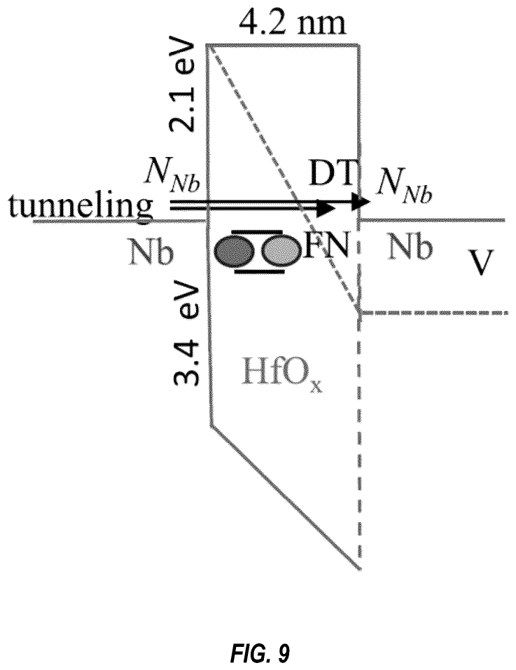

FIG. 9 is a representative energy band diagram illustrating the expected tunneling electron flow through the memristors 10, according to the present invention. As shown in FIG. 9, the expected tunneling electron flow, I, between normal metals at these warm temperatures, where T_{Nb-HfOx} is the transmission probability that can be understood from a Schrödinger solution and considering the presence of the ionic states impacting it is shown in Eq. 5, below,

$$I = \frac{2 π A}{h} {{\int }^{+ ∞}}_{- ∞} {\vert {T}_{NB - {HfO}_{x}} \vert}^{2} {N}_{Nb} ( ε - V ) {N}_{Nb} ( ε ) [ f ( ϵ - V ) - f ( ϵ ) ] d ε \qquad Eq . 5$$

where N_{Nb} are the density of electron states available for tunneling, and f is the Fermi-Dirac function. The changes in the memory response with increasing pulsing speed point to a combination of effects. The hysteresis is consistent with volatile ionic changes/motion due to the creation and motion of ionic oxygen vacancy states and any residual thermal fluctuations. The increasingly larger hysteresis of 0.5 V-0.7 V with 300 vs 60 ns pulsing and the more pronounced shoulder is indicative of negative differential resistance and the combined contributions of the partial ferro-electric effects and metal-insulator transitions due to the ionic composition and the Nb—HfOₓ interfaces.

The inventors also measured the full synthetic neuron 100 circuit response with the memristors 10 inserted in the feedback loops shown in FIG. 1. The measurements were performed with the memristors 10 probed on a chip while in a cryogenic probe station and wired up with discrete op-amp U2, resistors R1-R4, capacitors C1 and C2, and diode D1 that resided on an electronics breadboard.

FIG. 10 is a graph illustrating exemplary synthetic neuron output signals (OUT) with changing DC bias voltages, according to the present invention. More particularly, the inventors isolated a spiking mode with DC stimulus of ±2.2 V that is classical and stable in appearance to those produced with the Hodgkin-Huxley (HH) neuron model. FIG. 10 further illustrates adjusting the DC stimulus to ±2.4 and ±2.0 V to change the output response to a chaotic mode and a bursting mode, respectively. The extracted spiking rates for these modes are greater than 200 kHz with the MHz spectrum. To examine the degree of spike rate adaption (SRA) and other adaptive behaviors, which are common attributes in biological neurons and key for training and learning, the inventors also examined the addition of a small signal excitation.

FIG. 33 is a composite graph illustrating various exemplary types of spiking modes and the associated dynamical state variables produced by simulations of the synthetic neuron circuit 100 with changing levels of non-volatility, according to the present invention. The upper portion of each graph for each spiking mode represents the memristor dynamics and the lower portion of each graph represents the corresponding output or spiking mode. The various spiking modes, from left to right and top to bottom include transient, chaotic/irregular, tonic, resonant, adaptative, long burst/adaptive, hybrid and bursts with quiescence.

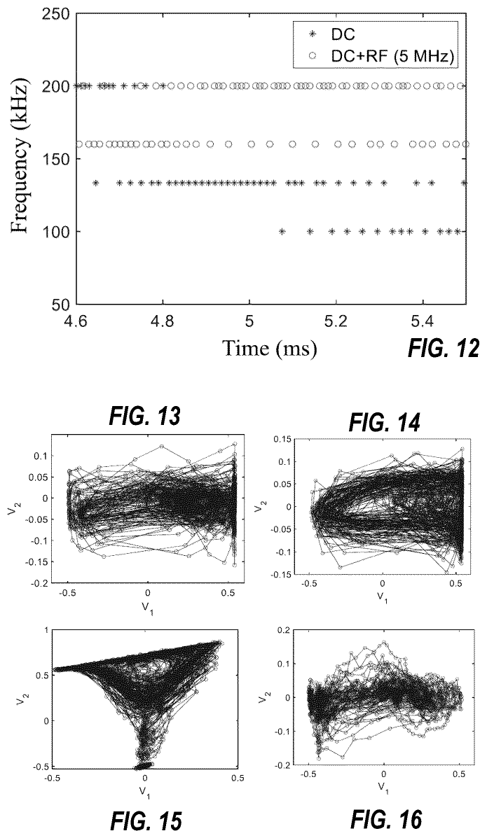

FIG. 11 is a graph of exemplary synthetic neuron output signals (OUT) with DC only and DC plus RF input (IN) stimulus, according to the present invention. More particularly, FIG. 11 compares the outputs with just the DC voltage stimulus and with an added RF sinusoidal stimulus (0.2 Vpp/5 MHz). FIG. 12 is a graph illustrating the extracted spiking rates vs time for the output signals illustrated in FIG. 11. More particularly, for the DC only input, the spiking rate adapts starting from around 200.1 KHz and reduces over the course of around half a milli-second to 100.3 kHz with a dependence like that produced with the biologically inspired adaptive exponential model (AdEx). In contrast with the added RF analog stimulus, the spiking rates start at 201.3 KHz and reduce to 160.2 kHz with a more abrupt transition that effectively produced a new bursting spiking mode as the adaptive response.

FIG. 13 is a graph illustrating an example of the phase-plane trajectories of a single artificial neuron at room temperature that produces hybrid non-chaotic/chaotic attractor modes, according to the present invention. With a single neuron, the attractors enter hybrid non-chaotic/chaotic modes with a distinct saddle point. FIGS. 14-16 are graphs illustrating examples of the phase-plane trajectories of multiple artificial neurons at room temperature, where the complexity observably increases, consistent with the formation of a neural network, according to the present invention.

### Quantum Control Effects

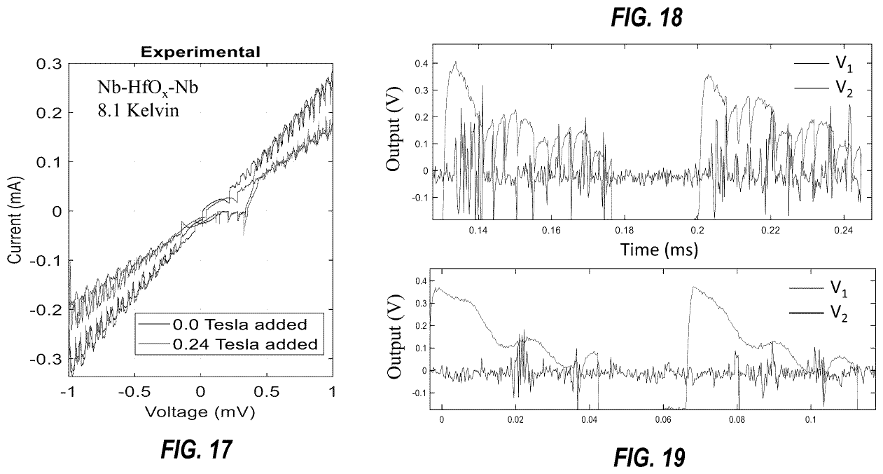

The inventors experimentally examined the effect of cryogenically cooling the synthetic neurons 100 into a superconducting state. FIG. 17 is a graph illustrating the measured current vs. voltage data of an embodiment of a Nb—HfOₓ—Nb memristor 10 taken at a temperature of 8.1 K sweeping from ±1.0 mV in the forward and reverse directions, according to the present invention. A critical current, due to cooper pair tunneling, a sum-gap voltage Δ=0.31 mV, and at increasing voltage a quasiparticle current. These characteristics have a hysteretic memory effect. With 0.24 T magnetic field applied, a decreased tunneling current is apparent and consistent with a Josephson tunneling junction with Nb electrodes. The characteristics are impacted by the excitation and decay of carriers into ionic centers where there is energy level splitting in the quantized environment. The fluctuations are attributed to residual noise with a thermal energy of 0.6 meV. The impacts of the cryogenic temperature and field effect further impacts the coherence length, ξₙ, shown in Eq. 6,

$${ξ}_{n} = {( \frac{D}{{k}_{B} T} \frac{ℏ}{2 π} )}^{1 / 2} \qquad Eq . 6$$

through the diffusion constant D=(1/3)vₜIₙ, with Fermi velocity vₜ, and Iₙ is the mean free path depending on the level of ionic states and h is the reduced Planck's constant, resulting in observable hysteresis.

The inventors also examined the output signal (OUT) of the artificial neuron circuit 100, while the memristors 10 were in a superconducting state. A periodic pulsed excitation with 0.4 to 0.5 ms widths was applied to the input signal (IN) of the artificial neuron 100. FIGS. 18 and 19 are graphs illustrating two examples of the collected experimental spectra with repeated measurement and modulated intensity, plotting the output voltages at the two respective memristor nodes (V₁ and V₂, see FIG. 1) vs. time, according to the present invention. It will be understood that measurement nodes may be selected to provide for probing of the dynamics of both memristor 10 devices as well as the influence of the spiking oscillator backbone (Wein oscillator) and the effect of networking. Multiple synthetic neurons may be employed if necessary to enable strong itinerant effects by networking neurons with different intrinsic attractor modes. It will also be understood that location of nodes can vary depending on the desired network outcome or learning strategy and the overall desired quantum mechanical algorithm of interest.

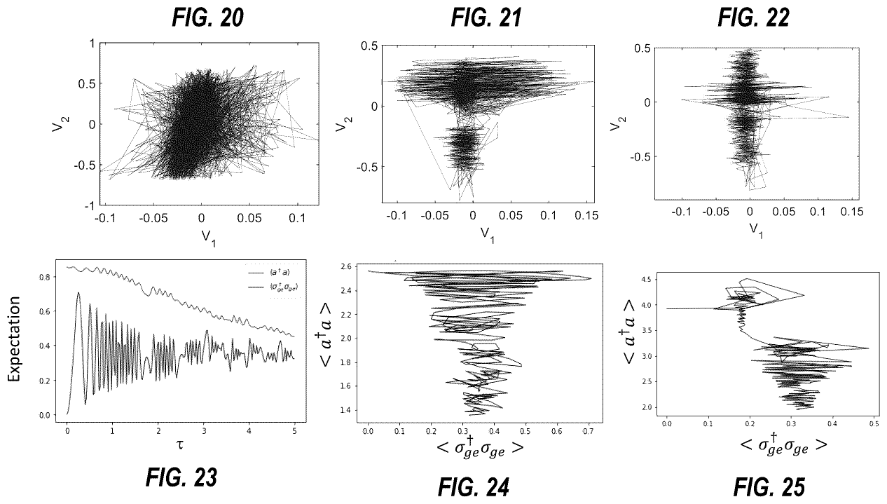

FIGS. 20-22 are graphs illustrating the phase-space for increasing excitation strength and when a network is formed, according to the present invention. More particularly the voltages at the two respective memristor nodes (V₁ and V₂, see FIG. 1) are plotted in FIGS. 20-22. The dynamical behavior observed in the experimental spectra appeared distinctly different and influenced from a quantum phenomenon occurring in the superconducting state and outside what can be modeled with Eqs. (1)-(3) for the warm temperature situation.

Investigating this notion further, the inventors performed calculations with the quantum master equation (QME), by modelling this solid state system as a quantum one analogous to an atomic system where the driving field is affected by the Josephson tunneling. This impacts the energy flow between the ionic states in HfOₓ. The inventors employed a modified type of Hamiltonian to represent transitions between ground |g [symbol] , excited |e [symbol] states, and their respective interactions with the driving field represented by the time dependence as a and σ_{ge}. The inventors introduced a strong-field time-dependent function with form

$$sin ( {( \frac{t}{e} )}^{2} )$$

to approximate the spiking oscillator backbone in Eq. 6,

$${H}_{super - ionic} ( t ) = - g ( {σ}_{ge}^{†} a + {a}^{†} {σ}_{ge} ) - A ( {σ}_{ge}^{†} + {σ}_{ge} ) sin ( {( \frac{t}{e} )}^{2} ) \qquad Eq . 6$$

where g is the coupling strength, A is the intensity, e the frequency of the driving field, and these parameters are calibrated. As a reminder, the QME describes the evolution of the density matrix,

$$ρ ( t ) : \frac{d ρ ( t )}{dt} = \frac{1}{ℏ} [ {H}_{super - ionic} ( t ) , ρ ( t ) ] + {\sum }_{n} \frac{1}{2} [ 2 {C}_{n} ρ ( t ) {C}_{n}^{†} - ρ ( t ) {C}_{n}^{†} {C}_{n} - {C}_{n}^{†} {C}_{n} ρ ( t ) ] \qquad Eq . 7$$

Dissipation is introduced through the collapse operators Cₙ and

$${C}_{n}^{†} ,$$

with rate of decay adjusted to 0.15 σ_{ge} and simulation of two conditions: (i) where the intensity of the driving field A=10 and a Hilbert space dimension of 4 and (ii) where the intensity of the driving field A=40 with a Hilbert space of 8 and plot the time evolution of [symbol] α^{†}α [symbol] and

$$〈 {σ}_{ge}^{†} {σ}_{ge} 〉$$

and also plotted against each other to represent the experimental data collected in the phase space.

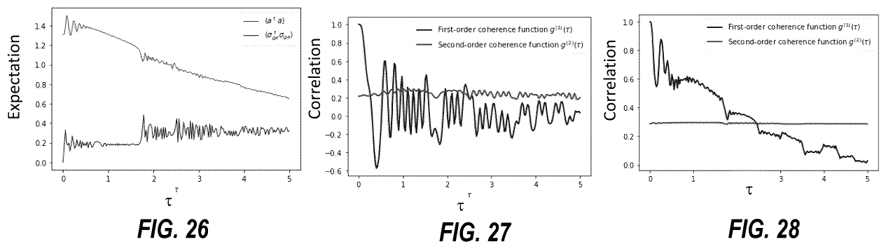

FIGS. 23-26 illustrate memristor output response based on the quantum master equation (QME) under different conditions, according to the present invention. More particularly, FIGS. 23 and 24 show the calculations for scenario (i) noted above. Whereas FIGS. 25 and 26 show the calculations for scenario (ii) noted above. The behavior in these simulations is in good qualitative agreement with the response observed experimentally. The larger Hilbert space required to capture the effects of the increasing driving field in the experiment points supports the notion that quantized energy level splitting is further enhanced and thus increases the dimensionality of the ionic states available for any coherent processes.

The inventors calculated the first and second order correlation functions g⁽¹⁾(t) and g⁽²⁾(t) as shown in Eqs. (8) and (9) below, which represent the level of quantum coherence and entanglement that could be supported:

$${g}^{( 1 )} ( t ) = \frac{〈 {a}^{†} ( t ) a ( 0 ) 〉}{\sqrt{〈 {a}^{†} ( t ) a ( t ) 〉 〈 {a}^{†} ( 0 ) a ( 0 ) 〉}} \qquad Eq . 8$$

$${g}^{( 2 )} ( t ) = \frac{〈 {a}^{†} ( 0 ) {a}^{†} ( t ) a ( t ) a ( 0 ) 〉}{{〈 {a}^{†} ( 0 ) a ( 0 ) 〉}^{2}} \qquad Eq . 9$$

FIGS. 27 and 28 illustrate the calculated correlation functions shown in Eqs. 8 and 9, according to the present invention. The first and second order correlation functions g⁽¹⁾(t) and g⁽²⁾(t) as shown in Eqs. (8) and (9) and their sustainment over the course of duration provides further evidence that quantum coherent control occurs under these conditions. Note that while this Lindblad formulation of the QME in Eq. (7) is appropriate for short-term memory effects, i.e., Markovian, the inventor's collected experimental data show some signs under network conditions that point to a time-delay reversal phenomenon, followed by re-establishment that occurs in the dynamical behavior, as shown by the time evolution in FIGS. 19-22.

### Strong Itinerancy and Simple Networks

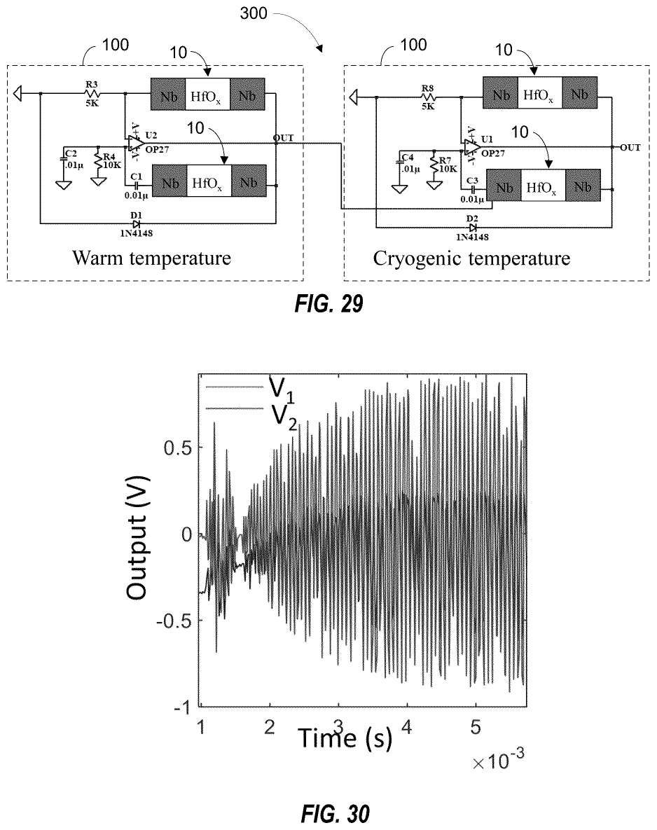

FIG. 29 is a two synthetic neuron network 300, according to the present invention. The neural network 300 includes two synthetic neurons 100 in a single row and with two columns. The memristors 10 of the first synthetic neuron 100 (left side) were maintained warm at room temperature. While the memristors 10 of the second neuron (right side) were cryogenically cooled to operate in the quantum control regime. The inventors optimized the network 300 for MHz speeds. The goal in creating network 300 was to provide a system where strong itinerant behavior becomes significantly pronounced by networking synthetic neurons 100 with very different intrinsic attractor modes and regimes of bifurcation.

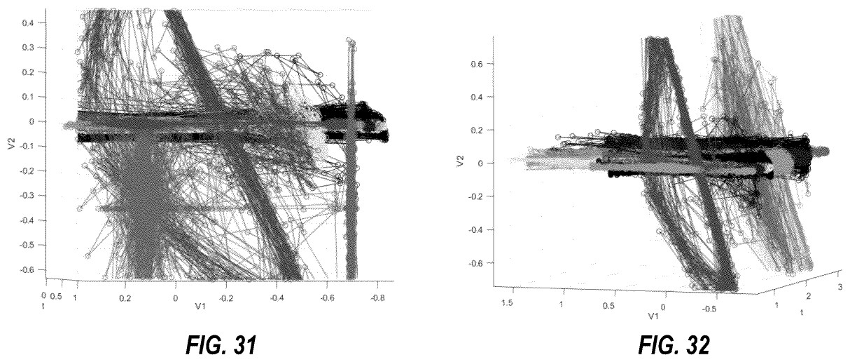

FIG. 30 is an exemplary graph of spiking output when the memristors 10 of one synthetic neuron 100 (right side) are cooled to 8.1 K, according to the present invention. FIGS. 31 and 32 are three-dimensional plots illustrating the two synthetic neuron network output voltage behavior as a function of time, according to the present invention. More particularly, as temperature is reduced, the collective behavior of the two neuron network 300 enters several regimes where the attractors show strong signs of itinerancy, i.e., behavior where time is spent in the trajectory of a dynamical attractor mode and then changes to several other modes. Such behaviors are commonly seen in the collective effects of biological neurons, and where, for example, such influence can result in spontaneous changes in motion and directionality of birds.

Having described particular embodiments of memristors, synthetic neurons and networks of synthetic neurons with reference to the drawings, additional general embodiments of the invention are disclosed below.

An embodiment of a memristor is disclosed. The embodiment of a memristor may include a first electrode formed of niobium. The embodiment of a memristor may further include a second electrode also formed of niobium. The embodiment of a memristor may further include an intermediate layer of ionically active hafnium oxide having a thickness, disposed in between, in electrical contact with, and separating the first and the second niobium electrodes. According to another embodiment of a memristor, the thickness of the intermediate layer is about 4.2 nm of ionically active hafnium oxide deposited by atomic layer deposition. According to yet another embodiment, the memristor may be formed on a silicon wafer substrate. According to particular embodiments, the first and the second niobium electrodes may be formed by sputtering.

An embodiment of a synthetic neuron for generating spiking modes mimicking biological neurons is disclosed. The embodiment of a synthetic neuron may have an input signal (IN) and an output signal (OUT). The embodiment of a synthetic neuron may further include an operational amplifier (U2) with a negative input, a positive input connected to the input signal, an output connected to the output signal, a positive DC bias voltage and a negative DC bias voltage. The embodiment of a synthetic neuron may further include a diode (D1) having anode connected to ground and cathode connected to the output signal. The embodiment of a synthetic neuron may further include a resistor (R3) connected between ground and the negative input. The embodiment of a synthetic neuron may further include a resistor (R4) connected between ground and the positive input. The embodiment of a synthetic neuron may further include a capacitor (C2) connected between ground and the positive input. The embodiment of a synthetic neuron may further include a first memristor having first and second electrodes, wherein the first electrode is connected to the negative input. The embodiment of a synthetic neuron may further include a resistor (R1) connected between the second electrode of the first memristor and the output signal. The embodiment of a synthetic neuron may further include a second memristor having first and second electrodes. The embodiment of a synthetic neuron may further include a capacitor (C1) connected between the positive input and the first electrode of the second memristor. The embodiment of a synthetic neuron may further include a resistor (R2) connected between the second electrode of the second memristor and the output signal.

According to another embodiment of a synthetic neuron, each of the first and the second memristors may include a first electrode formed of niobium, a second electrode also formed of niobium, and an intermediate layer of ionically active hafnium oxide having a thickness, disposed in between, in electrical contact with, and separating the first and the second electrodes. According to yet another embodiment of a synthetic neuron, the thickness of the intermediate layer of each of the memristors is about 4.2 nm of ionically active hafnium oxide deposited by atomic layer deposition. According to still another embodiment of a synthetic neuron, each of the memristors may further be formed on a silicon wafer substrate. According to still yet another embodiment of a synthetic neuron, the first and the second niobium electrodes of the memristor are formed by sputtering. According to various embodiments, the synthetic neuron may be configured to exhibit quantum tunneling, adaptivity and itinerant spiking modes by adjusting at least one of: the positive and/or the negative DC bias voltages of the operational amplifier, application of a DC or radio frequency signal to the input signal and chilling the synthetic neuron to a superconducting state (or regime). According to further embodiments of the synthetic neuron, the spiking modes may be selected from the following list of spiking modes: transient, chaotic/irregular, tonic, resonant, adaptative, long burst/adaptive, hybrid and bursts with quiescence. According to a particular embodiment of a synthetic neuron, operating at least one of the first and the second memristors in a superconducting state introduces Josephson tunneling across the at least one superconducting memristor with quantum control effects that influence ionic states which are adjustable by at least one of: the positive and the negative DC bias voltages of the operational amplifier and application of a DC or radio frequency signal to the input signal.

An embodiment of a neural network is disclosed. The embodiment of a neural network may include a plurality of synthetic neurons, arranged in columns and rows, each of the synthetic neurons configured for generating spiking modes mimicking biological neurons, having an input signal and an output signal. The embodiment of a neural network may further include the input signals of each column of the synthetic neurons are connected to each other and the output signals of each column of the synthetic neurons are connected together and to input signals of each subsequent column of the synthetic neurons.

According to another embodiment of a neural network, each of the synthetic neurons may include an operational amplifier (U2) with a negative input, a positive input connected to the input signal, an output connected to the output signal, a positive DC bias voltage and a negative DC bias voltage. According to this embodiment of a neural network, each of the synthetic neurons may further include a diode (D1) having anode connected to ground and cathode connected to the output signal. According to this embodiment of a neural network, each of the synthetic neurons may further include a resistor (R3) connected between ground and the negative input. According to this embodiment of a neural network, each of the synthetic neurons may further include a resistor (R4) connected between ground and the positive input. According to this embodiment of a neural network, each of the synthetic neurons may further include a capacitor (C2) connected between ground and the positive input. According to this embodiment of a neural network, each of the synthetic neurons may further include a first memristor having first and second electrodes, wherein the first electrode is connected to the negative input. According to this embodiment of a neural network, each of the synthetic neurons may further include a resistor (R1) connected between the second electrode of the first memristor and the output signal. According to this embodiment of a neural network, each of the synthetic neurons may further include a second memristor having first and second electrodes. According to this embodiment of a neural network, each of the synthetic neurons may further include a capacitor (C1) connected between the positive input and the first electrode of the second memristor. According to this embodiment of a neural network, each of the synthetic neurons may further include a resistor (R2) connected between the second electrode of the second memristor and the output signal.

According to yet another embodiment of a neural network, each of the first and the second memristors may further include a first electrode formed of niobium. According to this embodiment of a neural network, each of the first and the second memristors may further include a second electrode comprising niobium. According to this embodiment of a neural network, each of the first and the second memristors may further include an intermediate layer of ionically active hafnium oxide having a thickness, disposed in between, in electrical contact with, and separating the first and the second electrodes. According to a particular embodiment of a neural network, the thickness of the intermediate layer of the memristor may be about 4.2 nm of ionically active hafnium oxide deposited using atomic layer deposition (ALD) techniques. According to still yet another embodiment of a neural network, each of the memristors may further be formed on a silicon wafer substrate. According to one embodiment of a neural network, the first and the second niobium electrodes of the first and the second memristors are formed by sputtering.

According to still another embodiment of a neural network, each of the synthetic neurons may be configured to exhibit quantum tunneling, adaptivity and itinerant spiking modes by adjusting at least one of: the positive and/or the negative DC bias voltages of the operational amplifier (U2), application of a DC or radio frequency signal to the input signal and chilling the synthetic neuron to a superconducting state. According to a particular embodiment, the neural network further includes three rows and three columns. According to another particular embodiment, the neural network further includes one row and two columns. According to various embodiments of a neural network, the spiking modes may be any one of the following spiking modes: transient, chaotic/irregular, tonic, resonant, adaptative, long burst/adaptive, hybrid and bursts with quiescence. According to one embodiment of a neural network, operating at least one of the first and the second memristors in a superconducting state enables Josephson tunneling in the memristors, thereby enabling quantum control functions and quantum information processing.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed.

From the above description of the embodiments of synthetic neurons and networks with feedback quantum tunneling memristors, it is manifest that various alternative structures may be used for implementing features of the present invention without departing from the scope of the claims. The described embodiments are to be considered in all respects as illustrative and not restrictive. It will further be understood that the present invention may suitably comprise, consist of, or consist essentially of the component parts, method steps and limitations disclosed herein. The method and/or apparatus disclosed herein may be practiced in the absence of any element that is not specifically claimed and/or disclosed herein.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A memristor, comprising:
a first electrode comprising niobium (Nb);
a second electrode comprising Nb; and
an intermediate layer of ionically active hafnium oxide (HFOₓ) having a thickness, disposed in between, in electrical contact with, and separating the first and the second electrodes.

2. The memristor according to claim 1, wherein the thickness of the intermediate layer is about 4.2 nm of ionically active HFOₓ deposited via atomic layer deposition (ALD).

3. The memristor according to claim 1, further formed on a silicon wafer substrate.

4. The memristor according to claim 1, wherein the first and the second Nb electrodes are formed by sputtering.

5. A synthetic neuron for generating spiking modes mimicking biological neurons, the synthetic neuron having an input signal (IN) and an output signal (OUT), comprising:
an operational amplifier with a negative input, a positive input connected to the IN, an output connected to the OUT, a positive direct current (DC) bias voltage and a negative DC bias voltage;
a diode D1 having anode connected to ground and cathode connected to the OUT;
a resistor R3 connected between ground and the negative input;
a resistor R4 connected between ground and the positive input;
a capacitor C2 connected between ground and the positive input;
a first memristor having first and second electrodes, wherein the first electrode is connected to the negative input;
a resistor R1 connected between the second electrode of the first memristor and the OUT;
a second memristor having first and second electrodes;
a capacitor C1 connected between the positive input and the first electrode of the second memristor; and
a resistor R2 connected between the second electrode of the second memristor and the OUT.

6. The synthetic neuron according to claim 5, wherein each of the first and the second memristors comprise:
a first electrode comprising niobium (Nb);
a second electrode comprising Nb; and
an intermediate layer of ionically active hafnium oxide (HFOₓ) having a thickness, disposed in between, in electrical contact with, and separating the first and the second electrodes.

7. The synthetic neuron according to claim 6, wherein the thickness of the intermediate layer of each of the memristors is about 4.2 nm of ionically active HFOₓ deposited via atomic layer deposition (ALD).

8. The synthetic neuron according to claim 6, wherein each of the memristors is further formed on a silicon wafer substrate.

9. The synthetic neuron according to claim 6, wherein the first and the second Nb electrodes of the memristor are formed by sputtering.

10. The synthetic neuron according to claim 5, configured to exhibit quantum tunneling, adaptivity and itinerant spiking modes by adjusting at least one of:
the positive and/or the negative DC bias voltages of the operational amplifier;
application of a DC or radio frequency signal to the IN; and
chilling the synthetic neuron to a superconducting state.

11. The synthetic neuron according to claim 10, wherein the spiking modes are selected from the group consisting of: transient, chaotic/irregular, tonic, resonant, adaptative, long burst/adaptive, hybrid and bursts with quiescence.

12. The synthetic neuron according to claim 6, wherein operating at least one of the first and the second memristors in a superconducting state introduces Josephson tunneling across the at least one superconducting memristor with quantum control effects that influence ionic states which are adjustable by at least one of: the positive and the negative DC bias voltages of the operational amplifier and application of a DC or radio frequency signal to the IN.

13. A neural network, comprising:
a plurality of synthetic neurons, arranged in columns and rows, each of the synthetic neurons configured for generating spiking modes mimicking biological neurons, having an input signal (IN) and an output signal (OUT); and
wherein the IN of each column of the synthetic neurons are connected to each other and the OUT of each column of the synthetic neurons are connected together and to IN of each subsequent column of the synthetic neurons.

14. The neural network according to claim 13, wherein each of the synthetic neurons comprises:
an operational amplifier with a negative input, a positive input connected to the IN, an output connected to the OUT, a positive direct current (DC) bias voltage and a negative DC bias voltage;
a diode D1 having anode connected to ground and cathode connected to the OUT;
a resistor R3 connected between ground and the negative input;
a resistor R4 connected between ground and the positive input;
a capacitor C2 connected between ground and the positive input;
a first memristor having first and second electrodes, wherein the first electrode is connected to the negative input;
a resistor R1 connected between the second electrode of the first memristor and the OUT;
a second memristor having first and second electrodes;
a capacitor C1 connected between the positive input and the first electrode of the second memristor; and
a resistor R2 connected between the second electrode of the second memristor and the OUT.

15. The neural network according to claim 14, wherein each of the first and the second memristors comprise:
a first electrode comprising niobium (Nb);
a second electrode comprising Nb; and
an intermediate layer of ionically active hafnium oxide (HFOₓ) having a thickness, disposed in between, in electrical contact with, and separating the first and the second electrodes.

16. The neural network according to claim 15, wherein the thickness of the intermediate layer of the memristor is about 4.2 nm of ionically active HFOₓ deposited via atomic layer deposition (ALD).

17. The neural network according to claim 15, wherein each of the memristors is further formed on a silicon wafer substrate.

18. The neural network according to claim 15, wherein the first and the second Nb electrodes of the first and the second memristors are formed by sputtering.

19. The neural network according to claim 13, wherein each of the synthetic neurons is configured to exhibit quantum tunneling, adaptivity and itinerant spiking modes by adjusting at least one of:
the positive and/or the negative DC bias voltages of the operational amplifier;
application of a DC or radio frequency signal to the IN; and
chilling the synthetic neuron to a superconducting state.

20. The neural network according to claim 19, wherein the spiking modes are selected from the group consisting of: transient, chaotic/irregular, tonic, resonant, adaptative, long burst/adaptive, hybrid and bursts with quiescence.

21. The neural network according to claim 13, further comprises three rows and three columns.

22. The neural network according to claim 13, further comprises one row and two columns.

23. The neural network according to claim 14, wherein operating at least one of the first and the second memristors in a superconducting state enables Josephson tunneling in the memristors, thereby enabling quantum control functions and quantum information processing.
